(19) United States
(12) Patent Application Publication
(10) Pub. No.: US 2022/0383144 A1
(43) Pub. Date: Dec. 1, 2022

(54) APPARATUS AND METHOD FOR PREDICTING STATUS VALUE OF SERVICE MODULE BASED ON MESSAGE DELIVERY PATTERN

(71) Applicant: SAMSUNG SDS CO., LTD., Seoul (KR)

(72) Inventors: Seung-Hoon HA, Seoul (KR); Ji-Hee HONG, Seoul (KR)

(21) Appl. No.: 17/751,769

(22) Filed: May 24, 2022

(30) Foreign Application Priority Data
May 28, 2021 (KR) 10-2021-0069375

(51) Int. Cl. G06N 5/02

(52) U.S. Cl. CPC G06N 5/022

(57) ABSTRACT

A status value prediction device according to an embodiment includes a pattern extractor configured to extract at least one target message transfer pattern on basis of a message transferred between at least two or more of a plurality of service modules, a first trainer configured to generate a first variation prediction model for each of at least one target status value through training on basis of the at least one target message transfer pattern and the at least one target status value, and a second trainer configured to select at least one target event from among a plurality of events, and generate a second variation prediction model for each of the at least one target status value by additionally training the first variation prediction model.

### CROSS-REFERENCE TO RELATED APPLICATION(S)

This application claims the benefit under 35 USC § 119 of Korean Patent Application No. 10-2021-0069375, filed on May 28, 2021, in the Korean Intellectual Property Office, the entire disclosure of which is incorporated herein by reference for all purposes.

### BACKGROUND

### 1. Field

Embodiments disclosed herein relate to a technology for predicting a status value of a service module in a modularized system.

### 2. Description of Related Art

In a specifically modularized system such as a micro service architecture, a plurality of service modules that perform only particular functions respectively operate by exchanging messages. Conventionally, a separate agent is installed for each service module in order to monitor such a system, and a status value of a particular service module is measured through the agent. According to this scheme, a load on each service module increases due to the agent, and a measured status value is data limited to a particular service module, and thus a prediction range is narrow and it is difficult to perform analysis in association with another service module.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The disclosed embodiments are intended to provide a device and method for predicting a status value of a service module based on a message transfer pattern.

In one general aspect, there is provided a status value prediction device including: a pattern extractor configured to extract at least one target message transfer pattern on basis of a message transferred between at least two or more of a plurality of service modules; a first trainer configured to select, on basis of a correlation between the at least one target message transfer pattern and a plurality of status values of a target service module among the plurality of service modules, at least one target status value from among the plurality of status values, and generate a first variation prediction model for each of the at least one target status value through training on basis of the at least one target message transfer pattern and the at least one target status value; and a second trainer configured to select, on basis of a correlation between a plurality of preset events and the at least one target status value, at least one target event from among the plurality of events, and generate a second variation prediction model for each of the at least one target status value by additionally training the first variation prediction model for each of the at least one target status value on basis of the at least one target message transfer pattern, the at least one target status value, and the at least one target event.

The pattern extractor may generate a message transfer sequence for each of a plurality of transactions on basis of messages sequentially transferred between the at least two or more of the plurality of service modules in order to process at least one user request that has occurred within the same transaction, and extracts the at least one target message transfer pattern from the message transfer sequence for each of the plurality of transactions.

The pattern extractor may extract, as the at least one target message transfer pattern, at least one subsequence that has appeared at least a preset number of times in the message transfer sequence for each of the plurality of transactions.

The first trainer may calculate a correlation coefficient between the at least one target message transfer pattern and each of the plurality of status values, and select, as the at least one target status value, at least one status value having the correlation coefficient that is at least a preset value from among the plurality of status values.

The first trainer may perform training on the first variation prediction model for each of the at least one target status value by using, as independent variables, the at least one target status value at a point in time at which a message transferred to the target service module according to the at least one target message transfer pattern is generated and the at least one target message transfer pattern and using, as dependent variables, a variation in each of the at least one target status value after the point in time at which the message transferred to the target service module is generated.

The second trainer may additionally train the first variation prediction model for each of the at least one target status value by using, as independent variables, the at least one target status value at a point in time at which a message transferred to the target service module according to the at least one target message transfer pattern is generated, the at least one target message transfer pattern, and the at least one target event and using, as dependent variables, a variation in each of the at least one target status value after the point in time at which the message transferred to the target service module is generated.

The pattern extractor may identify a message transferred to the target service module according to one target message transfer pattern among the at least one target message pattern, after the second variation prediction model for each of the at least one target status value is generated.

The status value prediction device may further include a predictor configured to identify one or more events associated with the identified message among the at least one target event, and use the second variation prediction model for each of the at least one target status value to generate a prediction result for a variation in each of the at least one target status value of the target service module from the one target message transfer pattern, the identified at least one target event, and the at least one target status value of the target service module at a point in time at which the identified message is generated.

In another general aspect, there is provided a status value prediction method including: extracting at least one target message transfer pattern on basis of a message transferred between at least two or more of a plurality of service modules; selecting, on basis of a correlation between the at least one target message transfer pattern and a plurality of status values of a target service module among the plurality of service modules, at least one target status value from among the plurality of status values; generating a first variation prediction model for each of the at least one target status value through training on basis of the at least one target message transfer pattern and the at least one target status value; selecting, on basis of a correlation between a plurality of preset events and the at least one target status value, at least one target event from among the plurality of events; and generating a second variation prediction model for each of the at least one target status value by additionally training the first variation prediction model for each of the at least one target status value on basis of the at least one target message transfer pattern, the at least one target status value, and the at least one target event.

The extracting may include: generating a message transfer sequence for each of a plurality of transactions on basis of messages sequentially transferred between the at least two or more of the plurality of service modules in order to process at least one user request that has occurred within the same transaction; and extracting the at least one target message transfer pattern from the message transfer sequence for each of the plurality of transactions.

In the extracting, at least one subsequence that has appeared at least a preset number of times in the message transfer sequence for each of the plurality of transactions may be extracted as the at least one target message transfer pattern.

The selecting of the at least one target status value may include: calculating a correlation coefficient between the at least one target message transfer pattern and each of the plurality of status values; and selecting, as the at least one target status value, at least one status value having the correlation coefficient that is at least a preset value from among the plurality of status values.

In the generating of the first variation prediction model, the first variation prediction model for each of the at least one target status value may be trained by using, as independent variables, the at least one target status value at a point in time at which a message transferred to the target service module according to the at least one target message transfer pattern is generated and the at least one target message transfer pattern and using, as dependent variables, a variation in each of the at least one target status value after the point in time at which the message transferred to the target service module is generated.

In the generating of the second variation prediction model, the first variation prediction model for each of the at least one target status value may be additionally trained by using, as independent variables, the at least one target status value at a point in time at which a message transferred to the target service module according to the at least one target message transfer pattern is generated, the at least one target message transfer pattern, and the at least one target event and using, as dependent variables, a variation in each of the at least one target status value after the point in time at which the message transferred to the target service module is generated.

The status value prediction method may further include identifying a message transferred to the target service module according to one target message transfer pattern among the at least one target message pattern, after the second variation prediction model for each of the at least one target status value is generated.

The status value prediction method may further include: identifying one or more events associated with the identified message among the at least one target event; and using the second variation prediction model for each of the at least one target status value to generate a prediction result for a variation in each of the at least one target status value of the target service module from the one target message transfer pattern, the identified at least one target event, and the at least one target status value of the target service module at a point in time at which the identified message is generated.

### BRIEF DESCRIPTION OF THE DRAWINGS

FIG. 1 is a configuration diagram illustrating an example target system to which a resource usage amount prediction method on basis of message flow analysis is applied according to an embodiment.

FIG. 2 is a configuration diagram illustrating a status value prediction device according to an embodiment.

FIG. 3 is a diagram illustrating an example of a correlation between a message transfer pattern and a status value.

FIGS. 4 and 5 are diagrams illustrating examples of a first variation prediction model according to an embodiment.

FIG. 6 is a diagram illustrating an example of a correlation between an event and a status value of a target service module.

FIGS. 7 and 8 are diagrams illustrating examples of a second variation prediction model according to an embodiment.

FIG. 9 is a configuration diagram illustrating a status value prediction device according to an additional embodiment.

FIG. 10 is a flowchart illustrating a status value prediction method according to an embodiment.

FIG. 11 is a flowchart illustrating a status value prediction method according to an additional embodiment.

FIG. 12 is a block diagram exemplarily illustrating a computing environment that includes a computing device according to an embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, specific embodiments of the present disclosure will be described with reference to the accompanying drawings. The following detailed description is provided to assist in a comprehensive understanding of the methods, devices and/or systems described herein. However, the detailed description is only illustrative, and the present disclosure is not limited thereto.

In describing embodiments of the present disclosure, when a specific description of known technology related to the present disclosure is deemed to make the gist of the present disclosure unnecessarily vague, the detailed description thereof will be omitted. The terms used below are defined in consideration of functions in the present disclosure, but may vary in accordance with the customary practice or the intention of a user or an operator. Therefore, the terms should be defined on basis of whole content throughout the present specification. The terms used herein are only for describing the embodiments of the present disclosure, and should not be construed as limitative. A singular expression includes a plural meaning unless clearly used otherwise. In the present description, expressions such as “include” or “have” are for referring to certain characteristics, numbers, steps, operations, components, some or combinations thereof, and should not be construed as excluding the presence or possibility of one or more other characteristics, numbers, steps, operations, components, some or combinations thereof besides those described.

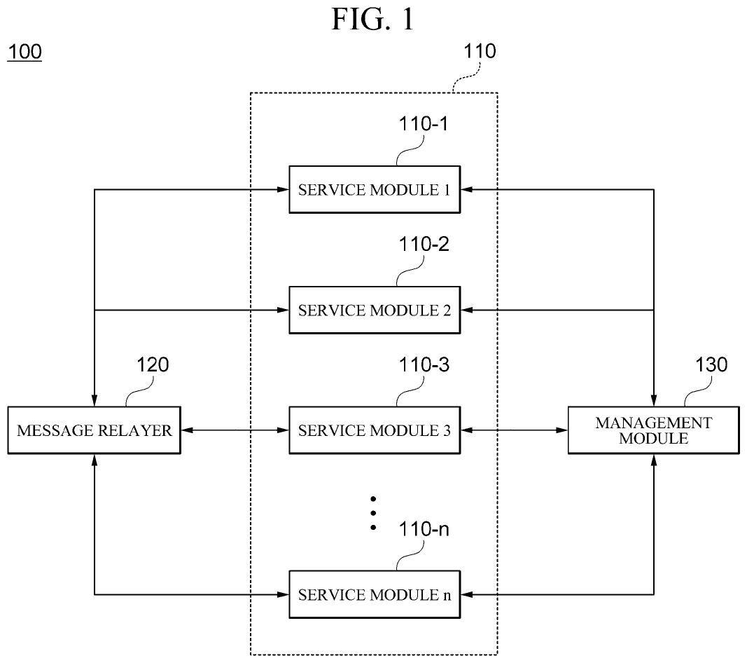

FIG. 1 is a configuration diagram illustrating an example target system to which a resource usage amount prediction method on basis of message flow analysis is applied according to an embodiment.

Referring to FIG. 1, a target system 100 according to an embodiment includes a plurality of service modules 110, a message relayer 120, and a management module 130.

In an embodiment, the target system 100 may be a system, in which services are classified by function, and thereafter the plurality of service modules 110 each perform a particular function among the classified functions. Here, the plurality of service modules 110, for example, may be designed on basis of a micro service architecture.

In detail, each of the plurality of service modules 110 may be a component for performing a particular function among a plurality of functions required for providing a service. For example, when some of functions provided by each of the plurality of service modules 110 are required to be processed sequentially according to a user request, the user request may be sequentially processed by service modules serving for respective functions among the plurality of service modules 110. Here, sequential processing results from the service modules serving for respective functions may be transferred in a message form through the message relayer 120.

The message relayer 120 is a module for relaying messages transferred between the plurality of service modules 110. According to an embodiment, the message relayer 120 may store, in a queue form, messages received from each of the service modules 110 and then transfer the messages to service modules that are destinations of the messages. Here, messages transferred between the plurality of modules 110 via the message relayer 120 may be transferred in a pre-agreed form within the target system 100 and may include, for example, message identification information (e.g., message ID), message departure point information (e.g., identification information of a service module that has transmitted a message), message destination information (e.g., identification information of a service module to receive a message), message occurrence time information, user information (e.g., user's age, gender, etc.), and the like. However, information included in the messages is not limited to the above examples, and may include another variety of information in addition to the above examples.

The management module 130 may monitor a plurality of status values for each of the service modules 110, and may control each of the service modules 110.

Here, according to an embodiment, the plurality of status values may be values indicating a status of a resource available for each of the service modules 110 to perform a particular function. For example, the plurality of status values may include central processing unit (CPU) usage, graphics processing unit (GPU) usage, memory usage, input/output operation per second (IOPS), storage usage, the number of processes being executed, the number of generated sockets, and the like. However, the plurality of status values are not limited to the above examples.

The configuration of the target system 100 illustrated in FIG. 1 is an example, and the target system is not limited to a system of a particular form provided that the target system is modularized for each function and operated through message communication between each module.

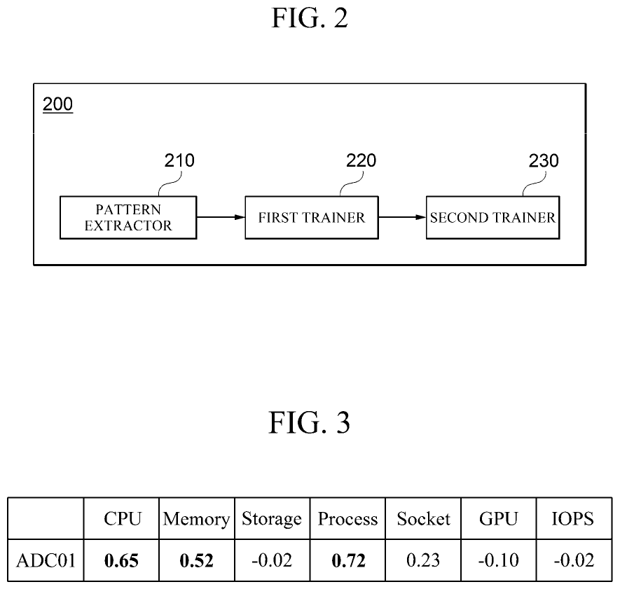

FIG. 2 is a configuration diagram illustrating a status value prediction device according to an embodiment.

Referring to FIG. 2, a status value prediction device 200 according to an embodiment includes a pattern extractor 210, a first trainer 220, and a second trainer 230.

The pattern extractor 210 extracts at least one target message transfer pattern on basis of messages transferred between at least two or more of the plurality of service modules 110.

According to an embodiment, the pattern extractor 210 may obtain messages transferred between the service modules 110 via the message relayer 120. Furthermore, the pattern extractor 210 may extract at least one target message transfer pattern on basis of message departure point information, destination information, and message occurrence time information included in each of obtained messages.

In detail, according to an embodiment, the pattern extractor 210 may generate a message transfer sequence for each of a plurality of transactions on basis of messages transferred between at least two or more of the plurality of service modules 110 via the message relayer 120 in order to process a user request within the same transaction. Here, the message transfer sequence may indicate an order in which messages have been transferred between one or more service modules among the plurality of service modules 110 in order to process at least one user request within one transaction.

According to an embodiment, the pattern extractor 210 may extract, as the target message transfer pattern, at least one subsequence that has appeared at least a preset number of times in the message transfer sequence for each of a plurality of transactions. Here, extraction of the subsequence may be performed using various known sequential pattern mining techniques such as Generalized Sequential Pattern (GSP) algorithm, PrefixSpan algorithm, Sequential Pattern Discovery using Equivalence classes (SPADE) algorithm, and the like.

As a specific example, it is assumed that a message was transferred from a service module 1 (110-1) to a service module 2 (110-2) via the message relayer 120 in order to process a login request of a user in a first transaction, a message was transferred from the service module 2 (110-2) to a service module 3 (110-3) after a message was transferred from the service module 1 (110-1) to the service module 2 (110-2) via the message relayer 120 in order to process a login process and a product recommendation request of the user in a second transaction, and a message was transferred from the service module 2 (110-2) to a service module n (110-n) after a message was transferred from the service module 1 (110-1) to the service module 2 (110-2) via the message relayer 120 in order to process a login request and a logout request of the user in a third transaction. In this case, the pattern extractor 210 may generate three message transfer sequences corresponding to respective transactions as shown in following Table 1.

TABLE 1

| Sequences | Message transfer sequences |
|---|---|
| 1 | {service module 1, service module 2} |
| 2 | {service module 1, service module 2, service module 3} |
| 3 | {service module 1, service module 2, service module n} |

Furthermore, when it is assumed that an appearance frequency of a subsequence to be extracted as a target message transfer pattern is 2, the pattern extractor 210 may extract {service module 1, service module 2} that is a subsequence included in each of sequence 1, sequence 2, and sequence 3 as a target message transfer pattern. According to an embodiment, the pattern extractor 210 may assign unique identification information to each of one or more extracted target message transfer patterns, and thereafter may store each of the target message transfer patterns together with the assigned identification information.

The first trainer 220 selects at least one target status value from among a plurality of status values on basis of a correlation between at least one target message transfer pattern and the plurality of status values of a target service module.

Here, according to an embodiment, the correlation between a target message transfer pattern and a status value of a target service module may indicate a degree of relationship between a message transferred to the target service module through the target message transfer pattern and a variation in the status value of the target service module.

In detail, according to an embodiment, the correlation between a target message transfer pattern and a status value of a target service module, for example, may be calculated using a Pearson correlation coefficient, and the first trainer 220 may select, as a target status value, a status value having a calculated correlation that is at least a preset first reference value among the plurality of status values of the target service module.

FIG. 3 is a diagram illustrating an example of a correlation between a message transfer pattern and a status value.

In detail, FIG. 3 illustrates an example of a Pearson correlation coefficient calculated between each of status values and a target message transfer pattern having identification information ‘ADC01’ assigned by the pattern extractor 210 when the status values of a target service module are respectively CPU usage, GPU usage, memory usage, IOPS, storage usage, the number of processes being executed, and the number of generated sockets.

In the example illustrated in FIG. 3, when it is assumed that the preset first reference value is 0.5, the first trainer 220 may select, as target status values, CPU usage, memory usage, and the number of processes being executed, which have a correlation coefficient of 0.5 or more.

When at least one target status value is selected, the first trainer 220 generates a first variation prediction model for each of the at least one target status value through training on basis of at least one target message transfer pattern and the at least one target status value.

Here, according to an embodiment, the first variation prediction model for each of at least one target status value may be a prediction model on basis of an artificial neural network and may be trained to predict a variation in a particular target status value among at least one target status value of a target service module from a message transfer pattern of a message transmitted to the target service module and the at least one target status value of the target service module.

In detail, according to an embodiment, the first trainer 220 may perform training on the first variation prediction model for each of at least one target status value by using, as independent variables, a target message transfer pattern and each of at least one target status value of the target service module at a point in time at which a message transferred to the target service module according to the message transfer pattern is generated and using, as dependent variables, a variation in each of the at least one target status value of the target service module after the point in time at which the message transferred to the target service module is generated. Here, the at least one target status value of the target service module, for example, may be obtained from the management module 130 of the target system 100, and the variation in each of the at least one target status value of the target service module after the point in time at which the message transferred to the target service module is generated may be calculated from at least one status value obtained from the management module 130 after the point in time.

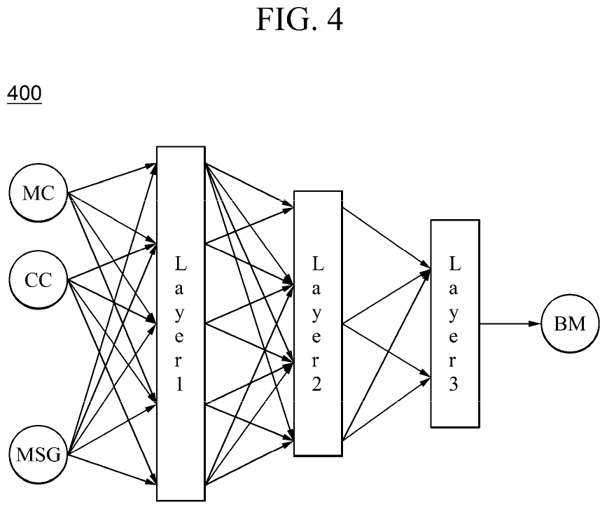

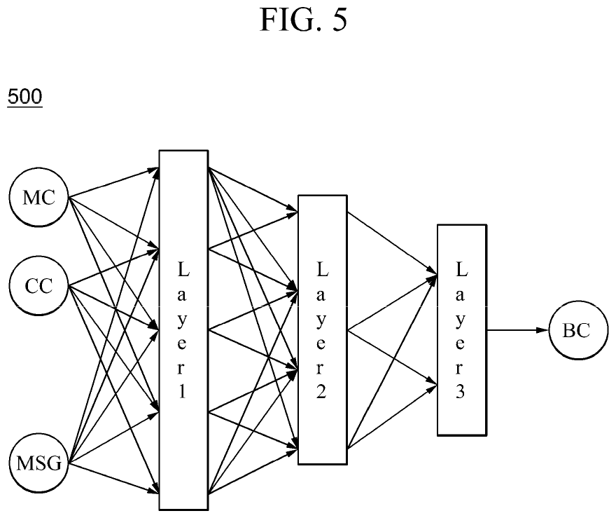

As a specific example, when the independent variables and dependent variables for training are as shown in following Table 2, the first variation prediction model for memory usage of a target service module, for example, may be generated through training on basis of the artificial neural network 400 illustrated in FIG. 4, and the first variation prediction model for CPU usage of a target service module, for example, may be generated through training on basis of the artificial neural network 500 illustrated in FIG. 5.

TABLE 2

| Variable | Variable | |
|---|---|---|
| type | name | Attribute |
| Independent | MC | Memory usage of a target service module when |
| variable | | receiving a message according to a target |
| | | message transfer pattern |
| Independent | CC | CPU usage of a target service module when |
| variable | | receiving a message according to a target |
| | | message transfer pattern |
| Independent | PC | Number of processes being executed in a target |
| variable | | service module when receiving a message |
| | | according to a target message transfer pattern |
| Independent | MSG | Target message transfer pattern |
| variable | | |
| Dependent | BM | Variation in memory usage of a target service |
| variable | | module after receiving a message according to |
| | | a target message transfer pattern |
| Dependent | BC | Variation in CPU usage of a target service |
| variable | | module after receiving a message according to |
| | | a target message transfer pattern |

Although the first variation prediction models 400 and 500 are illustrated as including three neural network layers in the examples of FIGS. 4 and 5, a neural network structure is not limited to a particular example, and may be variously configured according to embodiments. The second trainer 230 selects at least one target event from among a plurality of preset events on basis of a correlation between the plurality of events and at least one target status value.

Here, according to an embodiment, the plurality of events may include an event related to a point in time at which a message transferred to a target service module is generated, an event related to user information included in a message transferred to a target service module, and an event related to a service provided by the target system 100. Here, the event related to a point in time at which a message is generated, for example, may include a quarter, day, month, and time band to which the point in time at which the message is generated belongs. Furthermore, the event related to user information, for example, may include a user's gender and age. Furthermore, the event related to a service, for example, may include a sales event, promotion, and new product release provided at the point in time at which a message is generated.

The plurality of events may include, aside from the above examples, various types of events identifiable on basis of messages transferred between the plurality of service modules 110 of the target system 100, and may be variously set according to embodiments.

According to an embodiment, the correlation between an event and a target status value may indicate a degree of relationship between the event and a variation in the target status value of a target service module. In detail, according to an embodiment, the correlation between a particular event and a particular target status value of a target service module, for example, may be calculated using a Pearson correlation coefficient, and the second trainer 230 may select, as a target event, an event having a calculated correlation that is at least a preset second reference value among a plurality of events.

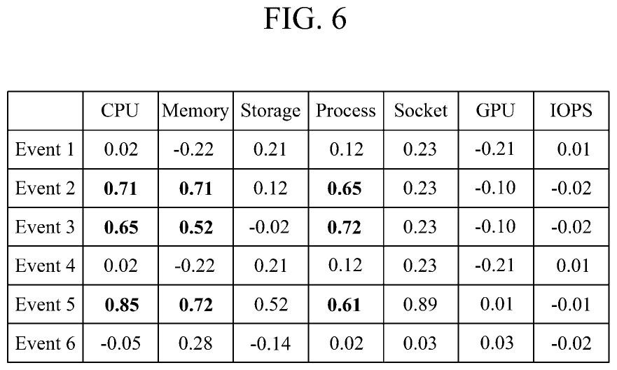

FIG. 6 is a diagram illustrating an example of a correlation between an event and a status value of a target service module.

In detail, FIG. 6 illustrates an example of a Pearson correlation coefficient calculated between each of status values and each of events when the status values of a target service module are respectively CPU usage, GPU usage, memory usage, IOPS, storage usage, the number of processes being executed, and the number of generated sockets, and preset events include six events (i.e., Event 1 to Event 6).

In the example illustrated in FIG. 6, when it is assumed that the target status values are ‘CPU usage’, ‘memory usage’, and ‘the number of processes being executed’, and the preset second reference value is 0.5, the second trainer 230 may select, as target events, Event 2, Event 3, and Event 5, which have a correlation coefficient of 0.5 or more with ‘CPU usage’, ‘memory usage’, and ‘the number of processes being executed’, from among the six events.

When at least one target event is selected, the second trainer 230 generates a second variation prediction model for each of at least one target status value by additionally training the first variation prediction model for each of the at least one target status value generated by the first trainer 220, on basis of the selected at least one target event, at least one target message transfer pattern, and the at least one target status value.

Here, according to an embodiment, the second variation prediction model for a particular target status value among the at least one target status value may be generated by additionally training the first variation prediction model so as to prediction a variation in the particular target status value among the at least one target status value of a target service module from a message transfer pattern of a message transferred to the target service module, at least one target event related to the message, and the at least one target status value of the target service module.

In detail, according to an embodiment, the second trainer 230 may add at least one target event as an independent variable for training in order to perform additional training on the first variation prediction model for each of at least one target status value.

As a specific example, when independent variables and dependent variables for training the first variation prediction model are as shown in above Table 2, and the target event selected by the second trainer 230 is Event 1, independent variables and dependent variables for additionally training the first variation prediction model may be as shown in following Table 3.

TABLE 3

| Variable | Variable | |
|---|---|---|
| type | name | Attribute |
| Independent | MC | Memory usage of a target service module when |
| variable | | receiving a message according to a target |
| | | message transfer pattern |
| Independent | CC | CPU usage of a target service module when |
| variable | | receiving a message according to a target |
| | | message transfer pattern |
| Independent | PC | Number of processes being executed in a target |
| variable | | service module when receiving a message |
| | | according to a target message transfer pattern |
| Independent | MSG | Target message transfer pattern |
| variable | | |
| Independent | EV1 | Target event |
| variable | | |
| Dependent | BM | Variation in memory usage of a target service |
| variable | | module after receiving a message according to |
| | | a target message transfer pattern |
| Dependent | BC | Variation in CPU usage of a target service |
| variable | | module after receiving a message according to |
| | | a target message transfer pattern |

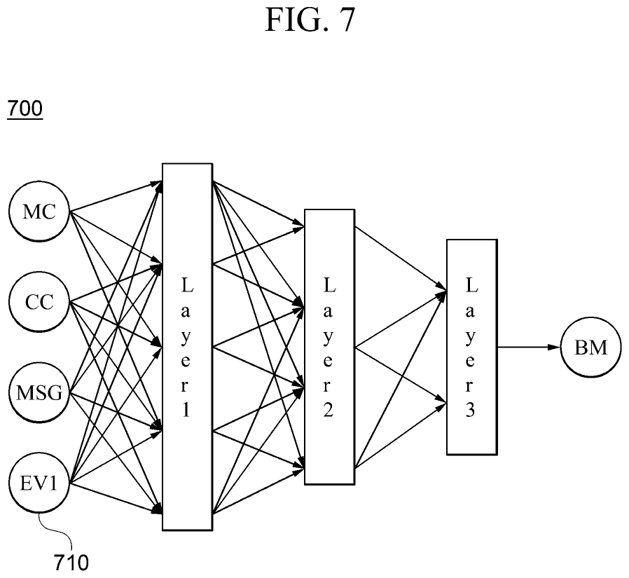

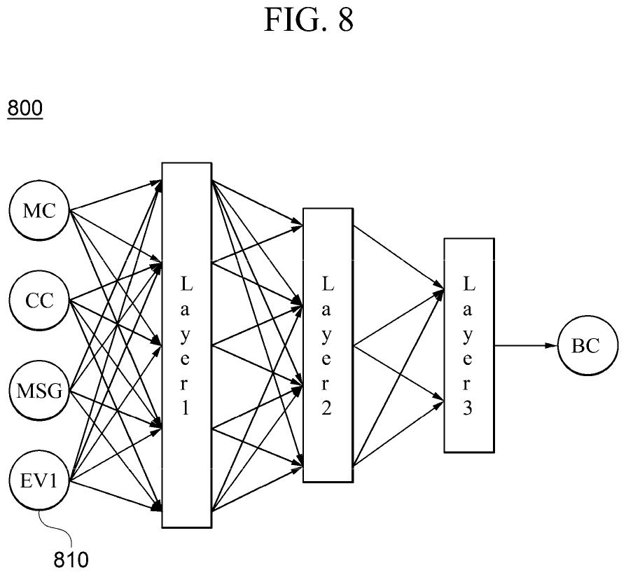

Here, when the first variation prediction model for memory usage of a target service module is as in the example illustrated in FIG. 4, the second trainer 230 may generate a second variation prediction model 700 for memory usage of the target service module through additional training after adding, as an independent variable, EV1 710 to the first variation prediction model 400 as illustrated in FIG. 7. Furthermore, when the first variation prediction model for CPU usage of a target service module is as in the example illustrated in FIG. 5, the second trainer 230 may generate a second variation prediction model 800 for CPU usage of the target service module through additional training after adding, as an independent variable, EV1 810 to the first variation prediction model 500 as illustrated in FIG. 8.

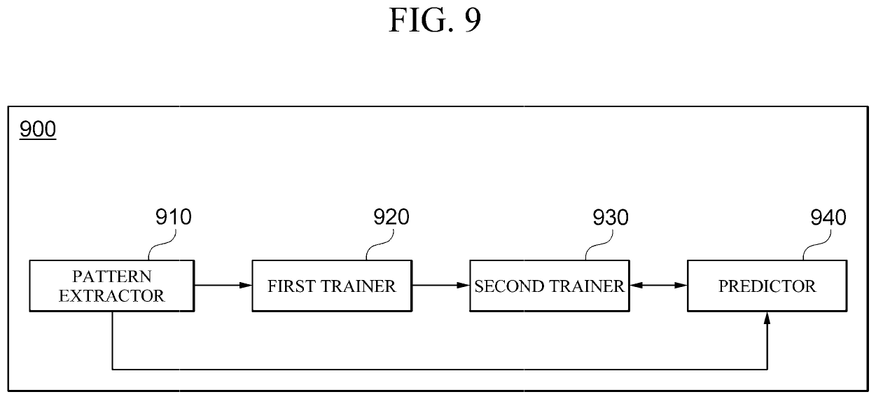

FIG. 9 is a configuration diagram illustrating a status value prediction device according to an additional embodiment.

Referring to FIG. 9, a prediction device 900 according to an additional embodiment includes a pattern extractor 910, a first trainer 920, a second trainer 930, and a predictor 940.

The pattern extractor 910, the first trainer 920, and the second trainer 930 in the embodiment illustrated in FIG. 9 are the same as the pattern extractor 210, the first trainer 220, and the third trainer 230 illustrated in FIG. 2, and thus overlapping descriptions thereof are not provided.

The pattern extractor 910 may identify a message transferred to a target service module according to a particular target message transfer pattern among at least one target message transfer pattern, after the second variation prediction model for each of at least one target status value of the target service module is generated by the second trainer 930.

The predictor 940 may identify at least one target event associated with the message identified by the pattern extractor 910 among at least one target event. Furthermore, the predictor 940 may use the second variation prediction model for each of the at least one target status value of the target service module to generate a prediction result for a variation in each of the at least one target status value of the target service module from a message transfer pattern of the identified message, the at least one identified target event, and the at least one target status value of the target service module at a point in time at which the identified message is generated.

Here, according to an embodiment, the at least one target event associated with the identified message, for example, may be identified on basis of generation time information, user information, and the like included in the identified message, and the at least one target status value of the target service module at the point in time at which the identified message is generated may be obtained from the management module 130 of the target system 100.

According to an embodiment, after generating the prediction result for a variation in each of the at least one target status value of the target service module, the predictor 940 may provide the generated prediction result to the management module 130 of the target system 100. In this case, the management module 130 may perform a preset control operation on the target service module on basis of the provided prediction result.

Furthermore, according to an embodiment, the predictor 940 may compare the prediction result for a variation in each of the at least one target status value of the target service module with an actual variation to determine, as a retraining target, the second variation prediction model of which a difference between the prediction result and the actual variation is at least a preset criterion among the second variation prediction models respectively for the at least one target status value. In this case, the second trainer 930 may perform retraining on the second variation prediction model determined as the retraining target by the predictor 940.

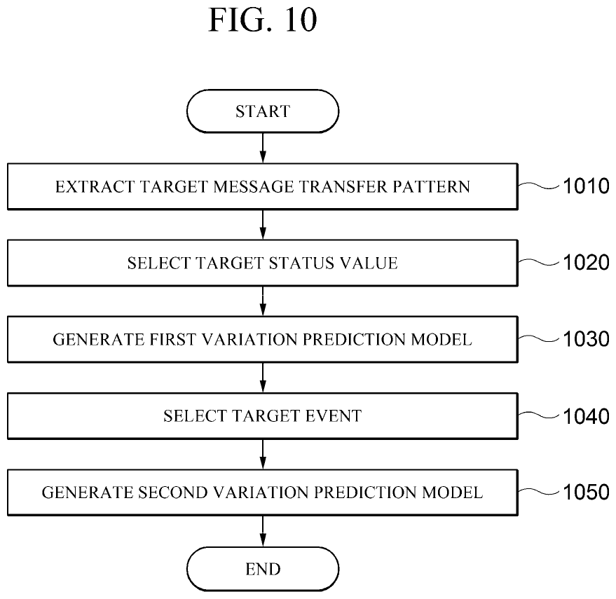

FIG. 10 is a flowchart illustrating a status value prediction method according to an embodiment.

The method illustrated in FIG. 10, for example, may be performed by the status value prediction device 200 or 900 illustrated in FIG. 2 or 9.

Referring to FIG. 10, the status value prediction device 200 or 900 extracts at least one target message transfer pattern on basis of messages transferred between at least two or more of the plurality of service modules 110 (1010).

Thereafter, the status value prediction device 200 or 900 selects at least one target status value from among a plurality of status values of a target service module among the plurality of service modules 100 on basis of a correlation between the at least one target message transfer pattern and the plurality of status values of the target service module (1020).

Thereafter, the status value prediction device 200 or 900 generates a first variation prediction model for each of the at least one target status value through training on basis of the at least one target message transfer pattern and the at least one target status value (1030).

Thereafter, the status value prediction device 200 or 900 selects at least one target event from among a plurality of preset events on basis of a correlation between the plurality of events and the at least one target status value (1040).

Thereafter, the status value prediction device 200 or 900 generates a second variation prediction model for each of the at least one target status value by additionally training the first variation prediction model for each of the at least one target status value, on basis of the at least one target message transfer pattern, the at least one target status value, and the at least one target event (1050).

In the flowchart illustrated in FIG. 10, at least two or more of the operations may be performed by changing the order of the operations, may be performed in combination with other operations, may be skipped, may be divided into detailed operations, or may be performed by adding at least one operation which is not shown.

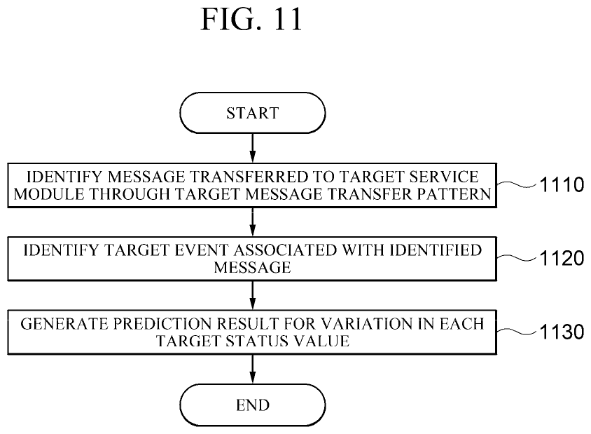

FIG. 11 is a flowchart illustrating a status value prediction method according to an additional embodiment.

The method illustrated in FIG. 11, for example, may be performed by the status value prediction device 900 illustrated in FIG. 9, after the second variation prediction model for each of at least one target status value is generated by the method illustrated in FIG. 10.

Referring to FIG. 11, the status value prediction device 900 identifies a message transferred to a target service module through one of at least one target message transfer pattern (1110).

Thereafter, the status value prediction device 900 identifies at least one target event associated with the identified message among at least one target event (1120).

Thereafter, the status value prediction device 900 uses the second variation prediction model for each of the at least one target status value of the target service module to generate a prediction result for a variation in each of the at least one target status value of the target service module from a target message transfer pattern of the identified message, the at least one identified target event, and the at least one target status value of the target service module at a point in time at which the identified message is generated (1130).

In the flowchart illustrated in FIG. 11, at least two or more of the operations may be performed by changing the order of the operations, may be performed in combination with other operations, may be skipped, may be divided into detailed operations, or may be performed by adding at least one operation which is not shown.

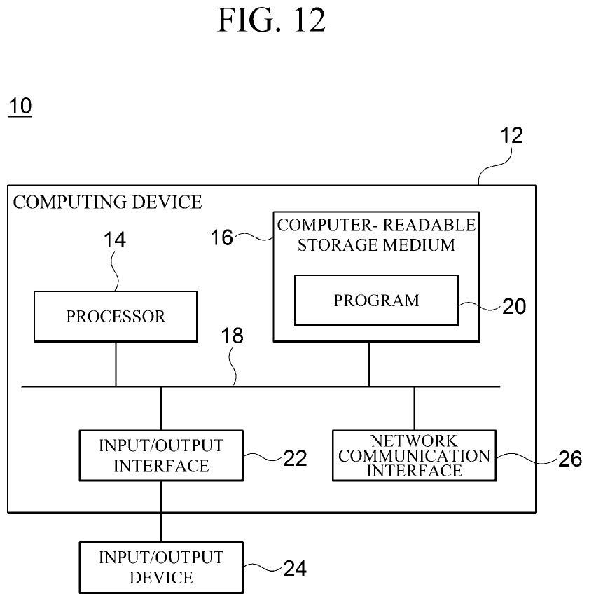

FIG. 12 is a block diagram exemplarily illustrating a computing environment that includes a computing device according to an embodiment. In the illustrated embodiment, each component may have different functions and capabilities in addition to those described below, and additional components may be included in addition to those described below.

The illustrated computing environment 10 includes a computing device 12. The computing device 12 may be one or more components included in the status value prediction device 200 or 900 according to an embodiment.

The computing device 12 includes at least one processor 14, a computer-readable storage medium 16, and a communication bus 18. The processor 14 may cause the computing device 12 to operate according to the above-described example embodiments. For example, the processor 14 may execute one or more programs stored in the computer-readable storage medium 16. The one or more programs may include one or more computer-executable instructions, which may be configured to cause, when executed by the processor 14, the computing device 12 to perform operations according to the example embodiments.

The computer-readable storage medium 16 is configured to store computer-executable instructions or program codes, program data, and/or other suitable forms of information. A program 20 stored in the computer-readable storage medium 16 includes a set of instructions executable by the processor 14. In an embodiment, the computer-readable storage medium 16 may be a memory (a volatile memory such as a random access memory, a non-volatile memory, or any suitable combination thereof), one or more magnetic disk storage devices, optical disk storage devices, flash memory devices, other types of storage media that are accessible by the computing device 12 and store desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 via the input/output interface 22. The example input/output device 24 may include a pointing device (a mouse, a trackpad, or the like), a keyboard, a touch input device (a touch pad, a touch screen, or the like), a voice or sound input device, input devices such as various types of sensor devices and/or imaging devices, and/or output devices such as a display device, a printer, a speaker, and/or a network card. The example input/output device 24 may be included inside the computing device 12 as a component constituting the computing device 12, or may be connected to the computing device 12 as a separate device distinct from the computing device 12.

According to the embodiments disclosed herein, it is possible to more accurately predict a status value for a target service module on basis of a message transfer pattern between a plurality of service modules, and a load on a system does not increase since it is not necessary to install an additional agent on the target service module.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A status value prediction device comprising:
a pattern extractor configured to extract at least one target message transfer pattern on basis of a message transferred between at least two or more of a plurality of service modules;
a first trainer configured to select, on basis of a correlation between the at least one target message transfer pattern and a plurality of status values of a target service module among the plurality of service modules, at least one target status value from the plurality of status values, and generate a first variation prediction model for each of the at least one target status value through training on basis of the at least one target message transfer pattern and the at least one target status value; and
a second trainer configured to select, on basis of a correlation between a plurality of preset events and the at least one target status value, at least one target event from the plurality of preset events, and generate a second variation prediction model for each of the at least one target status value by additionally training the first variation prediction model for each of the at least one target status value, on basis of the at least one target message transfer pattern, the at least one target status value, and the at least one target event.

2. The status value prediction device of claim 1, wherein the pattern extractor is configured to generate a message transfer sequence for each of a plurality of transactions, on basis of messages sequentially transferred between the at least two or more of the plurality of service modules in order to process at least one user request that has occurred within the same transaction, and extracts the at least one target message transfer pattern from the message transfer sequence for each of the plurality of transactions.

3. The status value prediction device of claim 2, wherein the pattern extractor is configured to extract, as the at least one target message transfer pattern, at least one subsequence that has appeared at least a preset number of times in the message transfer sequence for each of the plurality of transactions.

4. The status value prediction device of claim 1, wherein the first trainer is configured to calculate a correlation coefficient between the at least one target message transfer pattern and each of the plurality of status values, and select, as the at least one target status value, at least one status value, of which the correlation coefficient is at least a preset value, from the plurality of status values.

5. The status value prediction device of claim 1, wherein the first trainer is configured to perform training on the first variation prediction model for each of the at least one target status value by using, as independent variables, the at least one target status value at a point in time at which a message transferred to the target service module according to the at least one target message transfer pattern is generated and the at least one target message transfer pattern, and using, as dependent variables, a variation in each of the at least one target status value after the point in time at which the message transferred to the target service module is generated.

6. The status value prediction device of claim 1, wherein the second trainer is configured to additionally train the first variation prediction model for each of the at least one target status value by using, as independent variables, the at least one target status value at a point in time at which a message transferred to the target service module according to the at least one target message transfer pattern is generated, the at least one target message transfer pattern, and the at least one target event, and using, as dependent variables, a variation in each of the at least one target status value after the point in time at which the message transferred to the target service module is generated.

7. The status value prediction device of claim 1, wherein the pattern extractor is configured to identify a message transferred to the target service module according to a target message transfer pattern among the at least one target message pattern, after the second variation prediction model for each of the at least one target status value is generated.

8. The status value prediction device of claim 7, further comprising a predictor configured to identify one or more events associated with the identified message among the at least one target event, and use the second variation prediction model for each of the at least one target status value to generate a prediction result for a variation in each of the at least one target status value of the target service module from the a target message transfer pattern, the identified at least one target event, and the at least one target status value of the target service module at a point in time at which the identified message is generated.

9. A status value prediction method comprising:
extracting at least one target message transfer pattern on basis of a message transferred between at least two or more of a plurality of service modules;
selecting, on basis of a correlation between the at least one target message transfer pattern and a plurality of status values of a target service module among the plurality of service modules, at least one target status value from the plurality of status values;
generating a first variation prediction model for each of the at least one target status value through training on basis of the at least one target message transfer pattern and the at least one target status value;
selecting, on basis of a correlation between a plurality of preset events and the at least one target status value, at least one target event from the plurality of preset events; and
generating a second variation prediction model for each of the at least one target status value by additionally training the first variation prediction model for each of the at least one target status value, on basis of the at least one target message transfer pattern, the at least one target status value, and the at least one target event.

10. The status value prediction method of claim 9, wherein the extracting comprises:
generating a message transfer sequence for each of a plurality of transactions on basis of messages sequentially transferred between the at least two or more of the plurality of service modules in order to process at least one user request that has occurred within the same transaction; and
extracting the at least one target message transfer pattern from the message transfer sequence for each of the plurality of transactions.

11. The status value prediction method of claim 10, wherein in the extracting, at least one subsequence that has appeared at least a preset number of times in the message transfer sequence for each of the plurality of transactions is extracted as the at least one target message transfer pattern.

12. The status value prediction method of claim 9, wherein the selecting of the at least one target status value comprises:
calculating a correlation coefficient between the at least one target message transfer pattern and each of the plurality of status values; and
selecting, as the at least one target status value, at least one status value, of which the correlation coefficient is at least a preset value, from the plurality of status values.

13. The status value prediction method of claim 9, wherein in the generating of the first variation prediction model, the first variation prediction model for each of the at least one target status value is trained by using, as independent variables, the at least one target status value at a point in time at which a message transferred to the target service module according to the at least one target message transfer pattern is generated and the at least one target message transfer pattern and using, as dependent variables, a variation in each of the at least one target status value after the point in time at which the message transferred to the target service module is generated.

14. The status value prediction method of claim 9, wherein in the generating of the second variation prediction model, the first variation prediction model for each of the at least one target status value is additionally trained by using, as independent variables, the at least one target status value at a point in time at which a message transferred to the target service module according to the at least one target message transfer pattern is generated, the at least one target message transfer pattern, and the at least one target event and using, as dependent variables, a variation in each of the at least one target status value after the point in time at which the message transferred to the target service module is generated.

15. The status value prediction method of claim 9, further comprising identifying a message transferred to the target service module according to a target message transfer pattern among the at least one target message pattern, after the second variation prediction model for each of the at least one target status value is generated.

16. The status value prediction method of claim 15, further comprising:
identifying one or more events associated with the identified message among the at least one target event; and
using the second variation prediction model for each of the at least one target status value to generate a prediction result for a variation in each of the at least one target status value of the target service module from the one target message transfer pattern, the identified at least one target event, and the at least one target status value of the target service module at a point in time at which the identified message is generated.
